(19) United States
(12) Patent Application Publication
(10) Pub. No.: US 2020/0304263 A1
(43) Pub. Date: Sep. 24, 2020

(54) Method and Apparatus for Indicating and Receiving Signaling, and Communication System

(71) Applicant: FUJITSU LIMITED, Kawasaki-shi (JP)

(72) Inventors: Guoyu ZHANG, Beijing (CN); Lei SONG, Beijing (CN); Lei ZHANG, Beijing (CN); Xin WANG, Beijing (CN)

(73) Assignee: FUJITSU LIMITED, Kawasaki-shi (JP)

(21) Appl. No.: 16/896,653

(22) Filed: Jun. 9, 2020

Related U.S. Application Data
(63) Continuation of application No. PCT/CN2018/072130, filed on Jan. 10, 2018.

(51) Int. Cl. H04L 5/00; H04W 72/04

(52) U.S. Cl. CPC H04L 5/0048; H04W 72/0406; H04L 5/0053

(57) ABSTRACT

A method and an apparatus for indicating signaling, and a communication system. The method includes: transmitting configuration information by a network device to a terminal equipment, the configuration information including time domain position information on transmitting a reference signal at multiple time intervals by using reference signal resources in a reference signal resource set. Hence, even though reference signal resources at the same triggering state triggered for the same carrier frequency occupy multiple time intervals, the network device is able to accurately indicate information report by using triggering signaling, and the terminal equipment is also able to correctly interpret the triggering signaling.

### CROSS REFERENCE TO RELATED APPLICATIONS

This application is a continuation application of International Application No. PCT/CN2018/072130, filed on Jan. 10, 2018, the contents of which are incorporated herein by reference.

### TECHNICAL FIELD

This disclosure relates to the field of communication technologies, and in particular to a method and an apparatus for indicating and receiving signaling, and a communication system.

### BACKGROUND

It is provided in a new radio (NR) standard that when an aperiodic channel state information reference signal (CSI-RS) resource is used for aperiodic channel state information (CSI) report, a network device configures a time offset X for a CSI-RS resource set via a higher-layer configuration parameter AperiodicNZP-CSI-RS-TriggeringOffset. The time offset X is defined as a time interval between a time when triggering signaling of an aperiodic CSI-RS resource set is transmitted and a time when a CSI-RS is transmitted by using a CSI-RS resource in the aperiodic CSI-RS resource set, the time interval being in units of a slot.

The maximum number of CSI-RS resources in a CSI-RS set supported by the NR is not in excess of 64. And furthermore, it is provided in the standard that each triggering state in the triggering signaling may only trigger one resource set in the same CSI resource configuration (CSI-ResourceConfig).

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that when aperiodic CSI-RS resources are used for beam sweeping, if the number of CSI-RS resources included in an aperiodic resource set is relatively large, transmission is unable to be completed in orthogonal frequency division multiplexing (OFDM) symbols contained in a slot, or the number of CSI-RS resources exceeds an upper limit of the number of times of switching beams by a terminal equipment in a slot, and whether aperiodic CSI-RS resources at the same triggering state triggered for the same carrier frequency occupy multiple slots is supported still needs to be discussed. And furthermore, if such a mechanism is supported, problems of how to interpret a time offset X and how to indicate the mechanism need to be resolved.

Embodiments of this disclosure provide a method and an apparatus for indicating and receiving signaling, and a communication system, in which even though reference signal resources at the same triggering state triggered for the same carrier frequency occupy multiple time intervals, the network device is able to accurately indicate information report by using a triggering signaling, and the terminal equipment is also able to correctly interpret the triggering signaling.

According to a first aspect of the embodiments of this disclosure, there is provided a method for indicating signaling, including:
transmitting configuration information by a network device to a terminal equipment, the configuration information comprising time domain position information on transmitting a reference signal at multiple time intervals by using reference signal resources in a reference signal resource set; and
transmitting a triggering signaling by the network device to the terminal equipment, the triggering signaling being used to indicate transmitting the reference signal at the multiple time intervals by using the reference signal resources and indicate the terminal equipment to report channel state information.

According to a second aspect of the embodiments of this disclosure, there is provided an apparatus for indicating signaling, including:

a configuration transmitting unit configured to transmit configuration information to a terminal equipment, the configuration information comprising time domain position information on transmitting a reference signal at multiple time intervals by using reference signal resources in a reference signal resource set; and

a signaling transmitting unit configured to transmit a triggering signaling to the terminal equipment, the triggering signaling being used to indicate transmitting the reference signal at the multiple time intervals by using the reference signal resources and indicate the terminal equipment to report channel state information.

According to a third aspect of the embodiments of this disclosure, there is provided a method for indicating signaling, including:

transmitting configuration information on multiple reference signal resource sets by a network device to a terminal equipment, the configuration information comprising time domain position information on transmitting a reference signal at multiple time intervals by using reference signal resources in the multiple reference signal resource sets; and

transmitting a triggering signaling by the network device to the terminal equipment, the triggering signaling being used to indicate transmitting the reference signal at the multiple time intervals by using the reference signal resources in the multiple reference signal resource sets, and indicate the terminal equipment to report channel state information.

According to a fourth aspect of the embodiments of this disclosure, there is provided an apparatus for indicating signaling, including:

a configuration transmitting unit configured to transmit configuration information on multiple reference signal resource sets to a terminal equipment, the configuration information comprising time domain position information on transmitting a reference signal at multiple time intervals by using reference signal resources in the multiple reference signal resource sets; and

a signaling transmitting unit configured to transmit a triggering signaling to the terminal equipment, the triggering signaling being used to indicate transmitting the reference signal at the multiple time intervals by using the reference signal resources in the multiple reference signal resource sets, and indicate the terminal equipment to report channel state information.

According to a fifth aspect of the embodiments of this disclosure, there is provided a communication system, including:

a network device, including the apparatus for indicating signaling as described in the second or the fourth aspect.

An advantage of the embodiments of this disclosure exists in that the network device transmits configuration information to the terminal equipment, the configuration information including time domain position information on transmitting a reference signal at multiple time intervals by using reference signal resources in a reference signal resource set. Hence, even though reference signal resources at the same triggering state triggered for the same carrier frequency occupy multiple time intervals, the network device is able to accurately indicate information report by using a triggering signaling, and the terminal equipment is also able to correctly interpret the triggering signaling.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of a communication system of an embodiment of this disclosure;

FIG. 2 is a schematic diagram of a method for indicating signaling of Embodiment 1 of this disclosure;

FIG. 3 is an exemplary diagram of an aperiodic CSI-RS resource of Embodiment 1 of this disclosure;

FIG. 4 is a schematic diagram of a method for indicating and receiving signaling of Embodiment 1 of this disclosure;

FIG. 5 is another exemplary diagram of the aperiodic CSI-RS resource of Embodiment 1 of this disclosure;

FIG. 6 is a schematic diagram of a method for indicating signaling of Embodiment 2 of this disclosure;

FIG. 7 is a schematic diagram of a method for indicating and receiving signaling of Embodiment 2 of this disclosure;

FIG. 8 is an exemplary diagram of an aperiodic CSI-RS resource of Embodiment 2 of this disclosure;

FIG. 9 is a schematic diagram of an apparatus for indicating signaling of Embodiment 3 or 4 of this disclosure;

FIG. 10 is a schematic diagram of an apparatus for receiving signaling of Embodiment 3 or 4 of this disclosure;

FIG. 11 is a schematic diagram of a network device of Embodiment 5 of this disclosure; and

FIG. 12 is a schematic diagram of a terminal equipment of Embodiment 5 of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, and/or other communication protocols that are currently known or will be developed in the future.

In the embodiments of this disclosure, the term “network device”, for example, refers to an equipment in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC).

The base station may include but not limited to a node B (NodeB or NB), an evolved node B (eNodeB or eNB), and a 5G base station (gNB). Furthermore, it may include a remote radio head (RRH), a remote radio unit (RRU), a relay, or a low-power node (such as a femto, and a pico). The term “base station” may include some or all of its functions, and each base station may provide communication coverage for a specific geographical area. And a term “cell” may refer to a base station and/or its coverage area, which is dependent on a context of the term.

In the embodiments of this disclosure, the term “user equipment (UE)” or “terminal equipment (TE)” refers to, for example, equipment accessing to a communication network and receiving network services via a network device. The user equipment may be fixed or mobile, and may also be referred to as a mobile station (MS), a terminal, a subscriber station (SS), an access terminal (AT), or a station, etc.

The user equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal.

Furthermore, the term “network side” or “network device side” refers to a side of a network, which may be a base station, or may include one or more of the above network devices. And the term “user side” or “user equipment side” refers to a side of a user or a terminal, which may be a UE, or may include one or more of the above terminal equipments.

Scenarios in the embodiments of this disclosure shall be described below by way of examples; however, this disclosure is not limited thereto.

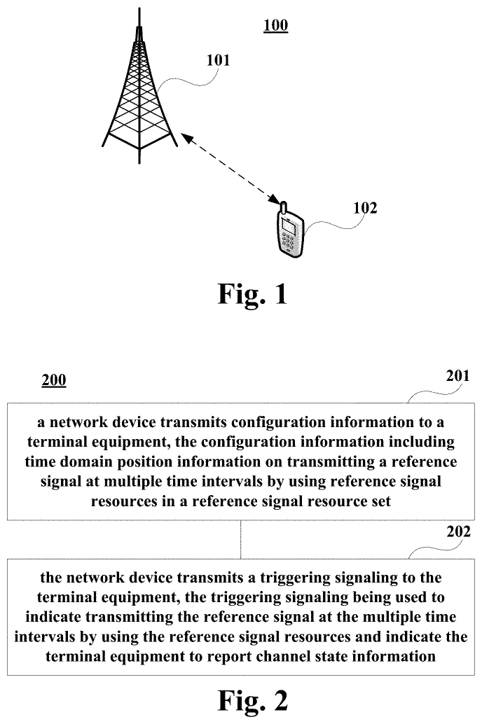

FIG. 1 is a schematic diagram of a communication system of an embodiment of this disclosure, in which a case where a network device and a user equipment are taken as examples is schematically shown. As shown in FIG. 1, a communication system 100 may include a network device 101 and a terminal equipment 102. For the sake of simplicity, description is given in FIG. 1 by taking one terminal equipment and one network device only as an example; however, the embodiments of this disclosure are not limited thereto.

In the embodiment of this disclosure, existing traffics or traffics that may be implemented in the future may be performed between the network device 101 and the terminal equipment 102. For example, such traffics may include but not limited to an enhanced mobile broadband (eMBB), massive machine type communication (MTC), and ultra-reliable and low-latency communication (URLLC).

In the following, the embodiment of this disclosure will be described by taking an NR system as an example. However, this disclosure is not limited thereto, and may also be applied to any system in which similar problems exist. And furthermore, the embodiment of this disclosure will be described by taking an aperiodic CSI-RS as an example. However, this disclosure is not limited thereto, and may also be applied to other reference signals or other scenarios.

### Embodiment 1

The embodiments of this disclosure provide a method for indicating signaling.

FIG. 2 is a schematic diagram of the method for indicating signaling of the embodiment of this disclosure, in which a case at a network device side is shown. As shown in FIG. 2, a method 200 for indicating signaling includes:

step 201: a network device transmits configuration information to a terminal equipment, the configuration information including time domain position information on transmitting a reference signal at multiple time intervals by using reference signal resources in a reference signal resource set; and

step 202: the network device transmits a triggering signaling to the terminal equipment, the triggering signaling being used to indicate transmitting the reference signal at the multiple time intervals by using the reference signal resources and indicate the terminal equipment to report channel state information.

In an embodiment, the reference signal resource is, for example, an aperiodic CSI-RS resource, the reference signal is, for example, an aperiodic CSI-RS, and the time interval may include, for example, at least one of the following: a slot, a frame, and a sub-frame. The time domain position information may be carried in one or more radio resource control (RRC) messages, and the triggering signaling is, for example, downlink control information (DCI) in a physical downlink control channel (PDCCH). However, this disclosure is not limited thereto, and following description shall be given by taking an aperiodic CSI-RS and a slot as examples.

In one embodiment, the time domain position information at least includes: an offset on a timeline of a time interval at which the reference signal is transmitted by using the reference signal resources in the reference signal resource set relative to a time interval of the triggering signaling, the offset being used to indicate a time domain position of a first time interval in the multiple time intervals.

In one embodiment, the configuration information further contains a first field, the first field indicating a time domain position of the reference signal resource in the reference signal resource set used for transmitting the reference signal at the multiple time intervals.

In one embodiment, the first field includes N parameters, one parameter in the N parameters corresponding to one time interval in the multiple time intervals; where, N is the number of the multiple time intervals. For example, one parameter in the N parameters is used to indicate the number of the reference signal resources used at the time interval. For another example, one parameter in the N parameters is used to indicate an index of a first reference signal resource used at the time interval in the reference signal resource set.

For example, the configuration information may include N values; where, N is the number of the time intervals. In this example, a maximum value N of the number of slots that is able to be spanned by an aperiodic CSI-RS resource in an aperiodic CSI-RS resource set needs to be supported.

For example, a time offset X is configured for each CSI-RS resource set via a higher layer configuration parameter, AperiodicNZP-CSI-RS-TriggeringOffset, and furthermore, a higher layer configuration parameter (which may be denoted as, for example, ResourceDistribution) may be added; the parameter denotes distribution of aperiodic CSI-RS resources in the CSI-RS resource set in each slot, and the time offset X denotes an offset between a slot where a first aperiodic CSI-RS resource in the CSI-RS resource set occurs and a slot where the triggering signaling is transmitted.

For example, in order to ensure the flexibility of invoking of the aperiodic CSI-RS resource set, this parameter may be configured in measurement configuration CSI-MeasIdToAddMod of link information report and the aperiodic CSI-RS resource set. The parameter may include N values, {n₁, n₂, . . . , n_{N}}, each value nᵢ indicating the number of aperiodic CSI-RS resources needing to be transmitted at an (l+X+i)-th slot indicated by it, 0≤nᵢ<K and Σᵢ₌₁^{N} n≤K; where, l denotes a sequence number of a slot for transmitting the triggering signaling of the aperiodic CSI-RS resource set, and K denotes the number of aperiodic CSI-RS resources included in the aperiodic CSI-RS resource set.

In one embodiment, the configuration information may further contain a second field, the second field being used to configure the reference signal resource set, and the index being determined by a configuration order of the reference signal resource in the second field.

For example, each value nᵢ indicates an index value of a first aperiodic CSI-RS resource transmitted at the (l+X+i)-th slot indicated by it in the aperiodic CSI-RS resource set (that is, indicating from which resource configured in the resource set starts the transmission at the slot). The index value is determined by an order in which aperiodic CSI-RS resources are configured in the aperiodic CSI-RS resource set, that is, an order in which the aperiodic CSI-RS resources appear is identical to an order in which the CSI-RS resources are configured in the aperiodic CSI-RS resource set.

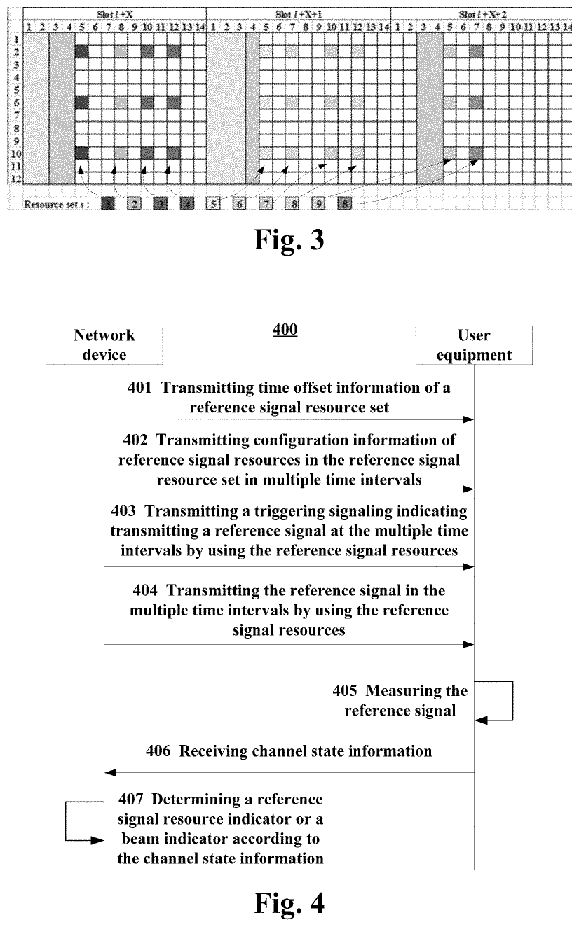

FIG. 3 is an exemplary diagram of an aperiodic CSI-RS resource of the embodiment of this disclosure. As shown in FIG. 3, for example, the aperiodic CSI-RS resource set s contains K=10 aperiodic CSI-RS resources. The parameter ResourceDistribution may be configured as {4, 4, 2}, indicating that three consecutive slots contain 4, 4, 2 resources, respectively; or, the parameter ResourceDistribution may be configured as {1, 5, 9}, indicating three consecutive slots transmit CSI-RSs starting respectively from the first, fifth and ninth resources in the resource set.

Hence, after the triggering signaling that triggers the aperiodic CSI-RS resource set s to transmit CSI-RSs is transmitted at an l-th slot, a first to fourth aperiodic CSI-RS resources configured in the aperiodic CSI-RS resource set swill be used to transmit the CSI-RSs at an (l+X)-th slot, a fifth to eighth aperiodic CSI-RS resources configured in the aperiodic CSI-RS resource set s will be used to transmit the CSI-RSs at an (l+X+1)-th slot, and a ninth and tenth aperiodic CSI-RS resources configured in the aperiodic CSI-RS resource set s will be used to transmit the CSI-RSs at an (l−X+2)-th slot.

It should be noted that this disclosure is exemplarily described above only; however, this disclosure is not limited thereto. And furthermore, the number of times of occurrences of the same aperiodic CSI-RS resource (such as that having a unique resource ID number) during configuration of the aperiodic CSI-RS resource set is not limited here. For example, in illustrated FIG. 3, the configured first periodic CSI-RS resource and the fifth and ninth aperiodic CSI-RS resources are all resources with the same resource ID. In this example, orders in which the aperiodic CSI-RS resources are transmitted in the slots are assigned according to orders in which the aperiodic CSI-RS resources are configured in the aperiodic CSI-RS resource set, without being limited by resource IDs.

In another embodiment, the first field contains a parameter M, the parameter M denoting that one or more reference signal resources in the reference signal resource set are used for transmitting the reference signal at M consecutive time intervals starting from the time interval indicated by the offset.

For example, a time offset X is configure for each CSI-RS resource set via a higher layer configuration parameter AperiodicNZP-CSI-RS-TriggeringOffset; and furthermore, a higher layer configuration parameter (which may be denoted as, for example, SlotRepetition) is added, which indicates a case of repeated occurrence of all aperiodic CSI-RS resources in the CSI-RS resource set in multiple slots.

For example, the configuration parameter may be a parameter M, indicating that all the aperiodic CSI-RS resources in the aperiodic CSI-RS resource set will occur in consecutive M slots starting from the (l−X)-th slot.

FIG. 4 is a schematic diagram of a method for indicating and receiving signaling of the embodiment of this disclosure, in which cases at a terminal equipment side and a network device side are shown. As shown in FIG. 4, a method 400 for indicating and receiving signaling includes:

step 401: a network device transmits time offset information of a reference signal resource set to a terminal equipment;

step 402: the network device transmits configuration information of reference signal resources in the reference signal resource set in multiple time intervals to the terminal equipment; and

step 403: the network device transmits to the terminal equipment a triggering signaling for indicating transmitting a reference signal at the multiple time intervals by using the reference signal resources.

For example, the time offset information and the configuration information may be carried in one or more RRC messages; for example, AperiodicNZP-CSI-RS-TriggeringOffset and ResourceDistribution, or AperiodicNZP-CSI-RS-TriggeringOffset and SlotRepetition, are transmitted via a message, that is, step 401 and step 402 may be combined; or AperiodicNZP-CSI-RS-TriggeringOffset and ResourceDistribution, or AperiodicNZP-CSI-RS-TriggeringOffset and SlotRepetition, may be transmitted via multiple messages, that is, step 401 and step 402 may be executed separately.

As shown in FIG. 4, the method 400 may further include:

step 404: the network device transmits the reference signal to the terminal equipment in the multiple time intervals by using the reference signal resources;

step 405: the terminal equipment measures the reference signal;

step 406: the terminal equipment reports channel state information to the network device; and

step 407: the network device determines, according to the channel state information, a reference signal resource indicator or a beam indicator reported by the terminal equipment.

It should be noted that FIG. 4 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 4.

In an embodiment, the reference signal resource indicator is used to indicate a reference signal resource (for example, preferred by a UE); the reference signal resource indicator may be an index of the reference signal resource, the index of the reference signal resource being an index of the reference signal resource in the reference signal resource set where it is located; or, it may be an index of the reference signal resource in a resource where the reference signal is located.

For example, if a UE receiving a CSI-RS is needed to report a CSI-RS resource indicator (CRI), the aperiodic CSI-RSs are transmitted by a base station via different beams in beam management, and the UE selects one or more measured better CSI-RSs and feeds back to the base station to achieve a purpose of beam selection. At this case, as aperiodic CSI-RS resources in the same aperiodic resource set may be used to repeatedly transmit CSI-RSs at different slots, in order not to cause confusion, the base station and the UE share a CRI calculation method, and the CRI at this moment denotes a beam ID number to some extent.

For example, the index of the reference resource is calculated by the following formula:

I_{resource}=k+K·p;

where, k denotes the index of the reference signal resource in the reference signal resource set, K denotes the number of reference signal resources included in the reference signal resource set, and p=[Iₛₗₒₜ−(l+X)] in this embodiment, Iₛₗₒₜ denoting an index of a time interval where the reference signal resource is located, X denoting the offset, l denoting a time interval where the triggering signaling is located, and p ∈ [0, N−1].

In another embodiment, the configuration information includes a bitmap used for indicating the time intervals at which the reference signal is transmitted. The bitmap contains S bits, the S bits corresponding to S consecutive time intervals starting from the time interval of the triggering signaling, and a bit in the S bits being used to indicate transmitting or not transmitting the reference signal within a corresponding time interval by using one or more of the reference signal resources in the reference signal resource set.

For example, the higher layer configuration parameter AperiodicNZP -CSI-RS-TriggeringOffset is configured in a bitmap form, a bit in the bitmap representing multiple consecutive slots starting from a slot at which the triggering signaling is transmitted, and a length of the bitmap being the number of slots , a value of which being, for example, a predefined fixed value.

For example, a bit set to be ‘1’ in the bitmap indicates that a CSI-RS resource included in the aperiodic resource set is used to transmit a CSI-RS in a slot denoted by the bit. For example, when a first bit of the bitmap is set to be ‘1’, it indicates that the CSI-RS resource in the aperiodic resource set is used to transmit the CSI-RS at a slot l when the triggering signaling is transmitted, that is, a triggering offset X=0; when an n-th bit of the bitmap is set to be ‘1’ and a preceding (n-1)-th bit is set to be ‘0’, it indicates that the CSI-RS resource in the aperiodic resource set is used to transmit the CSI-RS at a slot l+n-1, that is, a triggering offset X=n-1; and when multiple bits in the bitmap are set to be ‘1’, it indicates that the CSI-RS resource in the aperiodic resource set is used to transmit the CSI-RS at slots indicated by the bitmap. The indication mode in which multiple bits are set to be “1” is a case where the number of beams needing to be measured by the base station side in the beam management exceeds an upper limit of the number of times of switching beams by the UE in a slot.

In this embodiment, the time offset X may be indicated by the bitmap, that is, step 401 in FIG. 4 may be omitted. And the terminal equipment and the network device need to share a calculation method indicated by the reference signal resource, the calculation method being, for example, as described in the above formula. In this embodiment, p denotes that the reference resource needing to be reported by the UE is used in a time interval represented by a (p+1)-th bit set to be ‘1’ in the bitmap.

For another example, a bit set to be ‘0’ in the bitmap indicates that the CSI-RS resource included in the aperiodic resource set is used to transmit the CSI-RS in a slot represented by the bit. In this case, p indicates that the reference resource needing to be reported by the UE is used in a time interval represented by the (p+1)-th bit set to be ‘0’ in the bitmap.

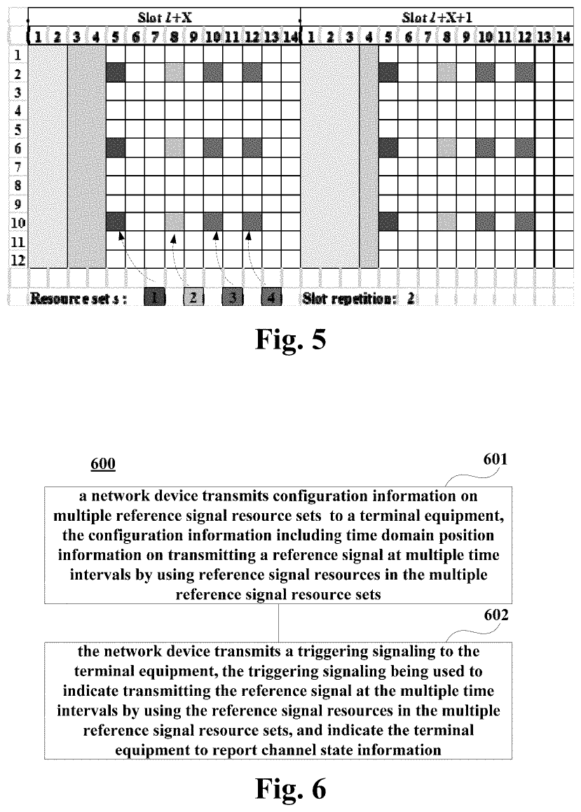

FIG. 5 is another exemplary diagram of the aperiodic CSI-RS resource of the embodiment of this disclosure. As shown in FIG. 5, for example, a method for indicating the time offset X and the parameter M may be used. For example, SlotRepetition is configured as 2, indicating that an aperiodic resource set including 4 aperiodic CSI-RS resources are repeatedly used in two consecutive slots starting from a slot l+X.

As a further example, a method of indicating by a bitmap may be used. For example, for a bitmap with SlotRepetition being configured as 0 . . . 0110 . . . 0, when bits X+1 and X+2 are set to be ‘1’, it indicates that four aperiodic CSI-RS resources in the aperiodic CSI-RS resource set are repeatedly used in slot l+X and slot l+X+1.

Furthermore, if a CRI needs to be fed back, for example, the UE needs to feed back a third resource in a second slot, where; K=4, k=3, Iₛₗₒₜ=l+X+1, and a value I_{resource}=7 of the CRI needing to be fed back may be obtained through calculating by using the formula. Likewise, the UE may inversely infer from the above formula to obtain which resource is transmitted and a slot at which the resource is transmitted.

In an embodiment, to support an aperiodic resource transmission mechanism in which multiple aperiodic CSI-RS resources triggered by triggering signaling are transmitted spanning multiple slots, configuration information may be used for configuration; and this mechanism is conducive to beam management in a case where a reception ability of the UE is limited.

In an embodiment, multiple RRC parameters may be added on the basis of the time offset X. When a CRI needs to be reported, an index of a resource in the set may be directly used without calculation. Furthermore, an RRC parameter may be added on the basis of the time offset X, or the time offset and the RRC parameter may be indicated via a bitmap. Thus, by repeated transmission of a resource set configured with a relatively small number of resources, measurement and report of multiple resources by the UE may be achieved.

It can be seen from the above embodiments that the network device transmits configuration information to the terminal equipment, the configuration information including time domain position information on transmitting a reference signal at multiple time intervals by using reference signal resources in a reference signal resource set. Hence, even though reference signal resources at the same triggering state triggered for the same carrier frequency occupy multiple time intervals, the network device is able to accurately indicate information report by using triggering signaling, and the terminal equipment is also able to correctly interpret the triggering signaling.

### Embodiment 2

The embodiments of this disclosure provide a method for indicating signaling, with contents identical to those in Embodiment 1 being not going to be described herein any further.

FIG. 6 is a schematic diagram of the method for indicating signaling of the embodiment of this disclosure, in which a case at a network device side is shown. As shown in FIG. 6, a method 600 for indicating signaling includes:

step 601: a network device transmits configuration information on multiple reference signal resource sets to a terminal equipment, the configuration information including time domain position information on transmitting a reference signal at multiple time intervals by using reference signal resources in the multiple reference signal resource sets; and

step 602: the network device transmits a triggering signaling to the terminal equipment, the triggering signaling being used to indicate transmitting the reference signal at the multiple time intervals by using the reference signal resources in the multiple reference signal resource sets, and indicate the terminal equipment to report channel state information.

In an embodiment, the time domain position information at least includes: an offset on a timeline of a time interval at which the reference signal is transmitted by using the reference signal resources in the multiple reference signal resource sets relative to a time interval of the triggering signaling, offsets of the multiple reference signal resource sets being different.

In an embodiment, the reference signal resources are, for example, aperiodic CSI-RS resources, the reference signal is an aperiodic CSI-RS, and the time interval includes at least one of the following: a slot, a frame, and a subframe. However, this disclosure is not limited thereto, and following description shall be given by taking an aperiodic CSI-RS and a slot as examples.

In an embodiment, a triggering state indicated by the triggering signaling may be associated with multiple aperiodic CSI-RS resource sets in the same resource configuration, the aperiodic CSI-RS resource sets being configured with different time offsets X, and when the triggering signaling indicates a certain triggering state, multiple aperiodic CSI-RS resource sets associated with it are simultaneously triggered. When this mechanism is adopted, for example, it needs to be specified in a protocol that when a triggering state connects with multiple aperiodic CSI-RS resource sets in the same resource configuration, the UE is needed to jointly report multiple aperiodic CSI-RS resource sets that are simultaneously triggered in the resource configuration.

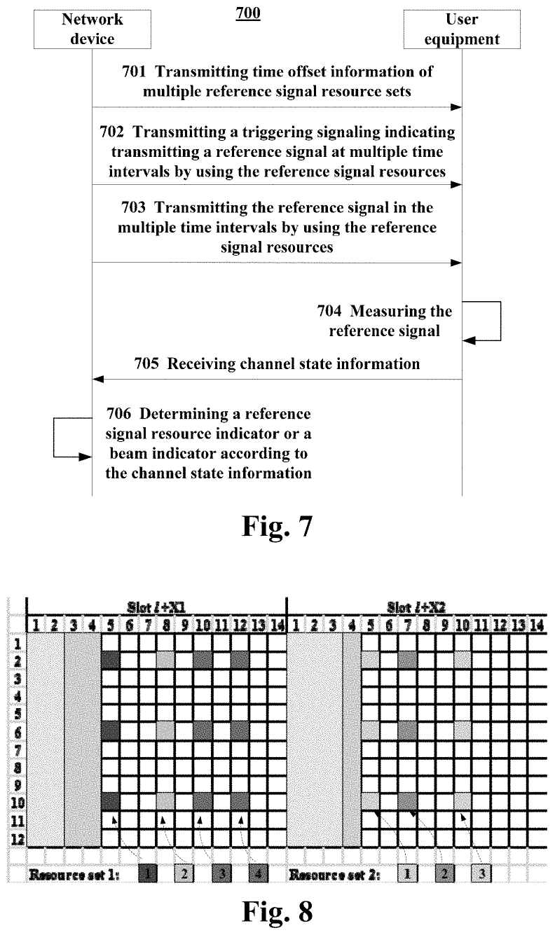

FIG. 7 is another schematic diagram of a method for indicating and receiving signaling of the embodiment of this disclosure, in which cases at a terminal equipment side and a network device side are shown. As shown in FIG. 7, a method 700 for indicating and receiving signaling includes:

step 701: a network device transmits time offset information of multiple reference signal resource sets to a terminal equipment, offsets of the multiple reference signal resource sets being different;

step 702: the network device transmits to the terminal equipment a triggering signaling for indicating transmitting a reference signal at multiple time intervals by using the reference signal resources.

As shown in FIG. 7, the method 700 may further include:

step 703: the network device transmits the reference signal to the terminal equipment in the multiple time intervals by using the reference signal resources;

step 704: the terminal equipment measures the reference signal;

step 705: the terminal equipment reports channel state information to the network device; and

step 706: the network device determines, according to the channel state information, a reference signal resource indicator or a beam indicator reported by the terminal equipment.

It should be noted that FIG. 7 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 7.

In an embodiment, the reference signal resource indicator is used to indicate a reference signal resource; the reference signal resource indicator may be an index of the reference signal resource, the index of the reference signal resource being an index of the reference signal resource in the reference signal resource set where it is located; or, it may be an index of the reference signal resource in a resource where the reference signal is located.

For example, the index of the reference signal resource is calculated by using the formula as follows:

I_{resource}=kₛ+Σᵢ₌₁^{s-1}Kᵢ;

where, kₛ denotes an index of a reference signal resource configured in a reference signal resource set s in the multiple reference signal resource sets, kₛ ∈ [1, Kₛ], and Kᵢ denotes the number of reference signal resources contained in a reference signal resource set i in the multiple reference signal resource sets.

FIG. 8 is another exemplary diagram of the aperiodic CSI-RS resource of the embodiment of this disclosure. As shown in FIG. 8, aperiodic CSI-RS resource sets 1 and 2 in the resource configuration are associated with the same triggering state. The aperiodic CSI-RS resource set 1 contains 4 aperiodic CSI-RS resources, and a time offset is X1; and the aperiodic CSI-RS resource set 2 contains 3 aperiodic CSI-RS resources, and a time offset is X2.

For example, after the triggering signaling indicating the trigger status is transmitted at the slot l, the UE will, at a slot l+X1, receive a CSI-RS transmitted by using a resource in the aperiodic CSI-RS resource set 1, and at a slot l+X2, receive a CSI-RS transmitted by using a resource in the aperiodic CSI-RS resource set 2.

After the UE measures the CSI-RSs to which the two aperiodic CSI-RS resource sets correspond, a report content is formed and transmitted to the base station. When the report content includes a CRI, if what needs to be reported is a first aperiodic CSI-RS resource in the second aperiodic CSI-RS resource set,

at this case, kₛ=k₂=1, the CRI needing to be reported may be obtained through calculation:

I_{resource}=k₂Σᵢ₌₁²⁻¹Kᵢ=1+4=5.

After the CRI is received, the base station may obtain through calculation according to the above formula which resource is fed back by the UE and which aperiodic CSI-RS resource set the resource is in.

In an embodiment, there is no need to add new RRC signaling, what is provided in an existing protocol that a triggering state activates a resource set in a resource configuration needs to be updated into that a triggering state activates multiple resource sets in a resource configuration, and measurement and report actions of the UE are constrained.

It can be seen from the above embodiments that the network device transmits configuration information to the terminal equipment, the configuration information including time domain position information on transmitting a reference signal at multiple time intervals by using reference signal resources in a reference signal resource set. Hence, even though reference signal resources at the same triggering state triggered for the same carrier frequency occupy multiple time intervals, the network device is able to accurately indicate information report by using triggering signaling, and the terminal equipment is also able to correctly interpret the triggering signaling.

### Embodiment 3

The embodiments of this disclosure provide an apparatus for indicating signaling. The apparatus may be, for example, a network device, or may be one or more components or assemblies configured in a network device. Contents in the embodiments identical to those in Embodiment 1 shall not be described herein any further.

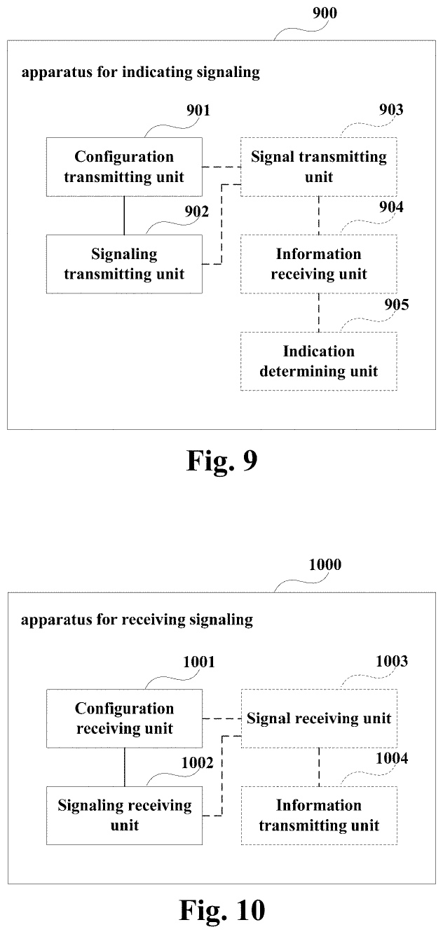

FIG. 9 is a schematic diagram of the apparatus for indicating signaling of the embodiment of this disclosure. As shown in FIG. 9, an apparatus 900 for indicating signaling includes:

a configuration transmitting unit 901 configured to transmit configuration information to a terminal equipment, the configuration information including time domain position information on transmitting a reference signal at multiple time intervals by using reference signal resources in a reference signal resource set; and

a signaling transmitting unit 902 configured to transmit a triggering signaling to the terminal equipment, the triggering signaling being used to indicate transmitting the reference signal at the multiple time intervals by using the reference signal resources and indicate the terminal equipment to report channel state information.

As shown in FIG. 9, the apparatus 900 may further include:

a signal transmitting unit 903 configured to transmit the reference signal at the multiple time intervals by using the reference signal resources.

As shown in FIG. 9, the apparatus 900 may further include:

an information receiving unit 904 configured to receive channel state information from the terminal equipment; and

an indication determining unit 905 configured to determine a reference signal resource indicator or a beam indicator reported by the terminal equipment, according to the channel state information.

The embodiment of this disclosure further provides an apparatus for receiving signaling. The apparatus may be, for example, a terminal equipment, or may be one or more components or assemblies configured in a terminal equipment.

FIG. 10 is a schematic diagram of the apparatus for receiving signaling of the embodiment of this disclosure. As shown in FIG. 10, an apparatus 1000 for receiving signaling includes:

a configuration receiving unit 1001 configured to receive configuration information transmitted by a network device, the configuration information including time domain position information on transmitting a reference signal at multiple time intervals by using reference signal resources in a reference signal resource set; and

a signaling receiving unit 1002 configured to receive a triggering signaling transmitted by the network device, the triggering signaling being used to indicate transmitting the reference signal at the multiple time intervals by using the reference signal resources and indicate the terminal equipment to report channel state information.

As shown in FIG. 10, the apparatus 1000 may further include:

a signal receiving unit 1003 configured to receive the reference signal transmitted by the network device at the multiple time intervals by using the reference signal resources.

As shown in FIG. 10, the apparatus 1000 may further include:

an information transmitting unit 1004 configured to report channel state information to the network device.

It should be noted that the components or modules related to this disclosure are only described above. However, this disclosure is not limited thereto, and the apparatus 900 for indicating signaling or the apparatus 1000 for receiving signaling may further include other components or modules, and reference may be made to related techniques for particulars of these components or modules.

Furthermore, for the sake of simplicity, connection relationships between the components or modules or signal profiles thereof are only illustrated in FIG. 9 or 10. However, it should be understood by those skilled in the art that such related techniques as bus connection, may be adopted. And the above components or modules may be implemented by hardware, such as a processor, a memory, a transmitter, and a receiver, etc., which are not limited in the embodiment of this disclosure.

It can be seen from the above embodiments that the network device transmits configuration information to the terminal equipment, the configuration information including time domain position information on transmitting a reference signal at multiple time intervals by using reference signal resources in a reference signal resource set. Hence, even though reference signal resources at the same triggering state triggered for the same carrier frequency occupy multiple time intervals, the network device is able to accurately indicate information report by using triggering signaling, and the terminal equipment is also able to correctly interpret the triggering signaling.

### Embodiment 4

The embodiments of this disclosure provide an apparatus for indicating signaling. The apparatus may be, for example, a network device, or may be one or more components or assemblies configured in a network device. Contents in this embodiment identical to those in Embodiment 2 shall not be described herein any further. And reference may be made to FIG. 9 for a structure of the apparatus for indicating signaling of the embodiments of this disclosure.

In an embodiment, the configuration transmitting unit 901 is configured to transmit configuration information on multiple reference signal resource sets to a terminal equipment, the configuration information including time domain position information on transmitting a reference signal at multiple time intervals by using reference signal resources in the multiple reference signal resource sets; and

the signaling transmitting unit 902 is configured to transmit a triggering signaling to the terminal equipment, the triggering signaling being used to indicate transmitting the reference signal at the multiple time intervals by using the reference signal resources in the multiple reference signal resource sets, and indicate the terminal equipment to report channel state information.

The embodiments of this disclosure further provide an apparatus for receiving signaling. The apparatus may be, for example, a terminal equipment, or may be one or more components or assemblies configured in a terminal equipment. And reference may be made to FIG. 10 for a structure of the apparatus for receiving signaling of the embodiments of this disclosure.

In an embodiment, the configuration receiving unit 1001 is configured to receive configuration information on multiple reference signal resource sets transmitted by a network device, the configuration information including time domain position information on transmitting a reference signal at multiple time intervals by using reference signal resources in the multiple reference signal resource sets; and

the signaling receiving 1002 is configured to receive a triggering signaling transmitted by the network device, the triggering signaling being used to indicate transmitting the reference signal at the multiple time intervals by using the reference signal resources in the multiple reference signal resource sets, and indicate the terminal equipment to report channel state information.

It can be seen from the above embodiments that the network device transmits configuration information to the terminal equipment, the configuration information including time domain position information on transmitting a reference signal at multiple time intervals by using reference signal resources in a reference signal resource set. Hence, even though reference signal resources at the same triggering state triggered for the same carrier frequency occupy multiple time intervals, the network device is able to accurately indicate information report by using triggering signaling, and the terminal equipment is also able to correctly interpret the triggering signaling.

### Embodiment 5

The embodiments of this disclosure provide a communication system, and reference may be made to FIG. 1, with contents identical to those in embodiments 1-4 being not going to be described herein any further. In the embodiments, the communication system 100 may include:

a network device 101 configured with the apparatus 900 for indicating signaling as described in Embodiment 3 or 4; and

a terminal equipment 102 configured with the apparatus 1000 for receiving signaling as described in Embodiment 3 or 4.

The embodiments of this disclosure further provide a network device, which may be, for example, a base station. However, this disclosure is not limited thereto, and it may also be another network device.

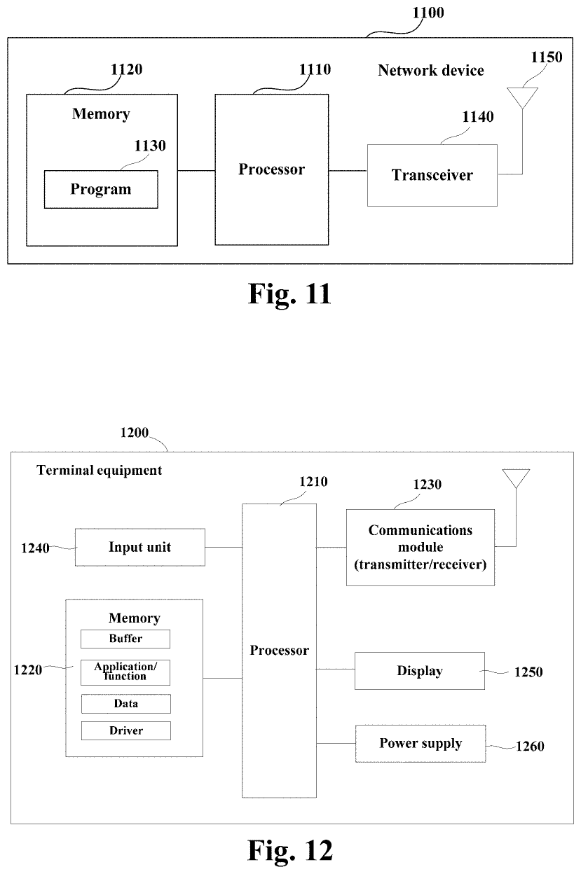

FIG. 11 is a schematic diagram of a structure of the network device of the embodiment of this disclosure. As shown in FIG. 11, a network device 1100 may include a processor 1110 (such as a central processing unit (CPU)) and a memory 1120, the memory 1120 being coupled to the processor 1110. The memory 1120 may store various data, and furthermore, it may store a program 1130 for data processing, and execute the program 1130 under control of the processor 1110.

For example, the processor 1110 may be configured to execute the program 1130 to carry out the method for indicating signaling described in Embodiment 1. For example, the processor 1110 may be configured to execute the following control: transmitting configuration information to a terminal equipment, the configuration information including time domain position information on transmitting a reference signal at multiple time intervals by using reference signal resources in a reference signal resource set; and transmitting a triggering signaling to the terminal equipment, the triggering signaling being used to indicate transmitting the reference signal at the multiple time intervals by using the reference signal resources and indicate the terminal equipment to report channel state information.

In one embodiment, the time domain position information at least includes: an offset on a timeline of a time interval at which the reference signal is transmitted by using the reference signal resources in the reference signal resource set relative to a time interval of the triggering signaling, the offset being used to indicate a time domain position of a first time interval in the multiple time intervals.

In one embodiment, the reference signal resources are aperiodic channel state information reference signal resources, the reference signal is aperiodic channel state information reference signal, and the time interval includes at least one of the following: a slot, a frame, and a subframe; and the configuration information is carried by one or more radio resource control messages.

In one embodiment, the configuration information further contains a first field, the first field indicating time domain positions of the reference signal resources in the reference signal resource set used for transmitting the reference signal at the multiple time intervals.

In one embodiment, the first field includes N parameters, one parameter in the N parameters corresponding to one time interval in the multiple time intervals; where, N is the number of the multiple time intervals.

In one embodiment, one parameter in the N parameters is used to indicate the number of the reference signal resources used at the time interval.

In one embodiment, one parameter in the N parameters is used to indicate an index of a first reference signal resource used at the time interval in the reference signal resource set.

In one embodiment, the configuration information further contains a second field, the second field being used to configure the reference signal resource set, and the index being determined by a configuration order of the first reference signal resource in the second field.

In one embodiment, the first field contains a parameter M, the parameter M denoting that one or more reference signal resources in the reference signal resource set are used for transmitting the reference signal at M consecutive time intervals starting from the time interval indicated by the offset.

In one embodiment, the configuration information contains a bitmap used for indicating the time intervals at which the reference signal is transmitted; wherein, the bitmap contains S bits, the S bits corresponding to S consecutive time intervals starting from the time interval of the triggering signaling, and a bit in the S bits being used to indicate transmitting or not transmitting the reference signal within a corresponding time interval by using one or more of the reference signal resources in the reference signal resource set.

In one embodiment, the processor 1110 may further be configured to perform the following control: receiving channel state information from the terminal equipment; and determining a reference signal resource indicator or a beam indicator reported by the terminal equipment, according to the channel state information.

In one embodiment, the reference signal resource indicator is used to indicate a reference signal resource, and is an index of the reference signal resource; wherein, the index of the reference signal resource is an index in the reference signal resource set where the reference signal resource is located, or is an index of the reference signal resource in a resource where the reference signal is located.

In one embodiment, the index of the reference signal resource is calculated by using the formula as follows:

I_{resource}=k+K·p;

where, k denotes the index of the reference signal resource in the reference signal resource set, K denotes the number of reference signal resources contained in the reference signal resource set, p=[Iₛₗₒₜ−(l+X)], Iₛₗₒₜ denoting an index of the time interval of the reference signal resource, X denoting the offset, and l denoting an index of the time interval of the triggering signaling; or, the reference signal resource needing to be reported by the terminal equipment is used at a time interval to which a (p+1)-th bit set to be “1” in the bitmap corresponds, or, the reference signal resource needing to be reported by the terminal equipment is used at a time interval to which a (p+1)-th bit set to be “0” in the bitmap corresponds.

For another example, the processor 1110 may be configured to execute the program 1130 to carry out the method for indicating signaling described in Embodiment 2. For example, the processor 1110 may be configured to execute the following control: transmitting configuration information on multiple reference signal resource sets to a terminal equipment, the configuration information including time domain position information on transmitting a reference signal at multiple time intervals by using reference signal resources in the multiple reference signal resource sets; and transmitting a triggering signaling to the terminal equipment, the triggering signaling being used to indicate transmitting the reference signal at the multiple time intervals by using the reference signal resources in the multiple reference signal resource sets, and indicate the terminal equipment to report channel state information.

In one embodiment, the time domain position information at least includes: an offset on a timeline of a time interval at which the reference signal is transmitted by using the reference signal resources in the multiple reference signal resource sets relative to a time interval of the triggering signaling, offsets of the multiple reference signal resource sets being different.

In one embodiment, the reference signal resources are aperiodic channel state information reference signal resources, the reference signal is an aperiodic channel state information reference signal, and the time interval includes at least one of the following: a slot, a frame, and a subframe.

In one embodiment, the processor 1110 may further be configured to execute the following control: receiving channel state information from the terminal equipment; and determining a reference signal resource indicator or a beam indicator reported by the terminal equipment, according to the channel state information.

In one embodiment, the reference signal resource indicator is used to indicate a reference signal resource, and is an index of the reference signal resource; wherein, the index of the reference signal resource is an index in a reference signal resource set where the reference signal resource is located, or is an index of the reference signal resource in a resource where the reference signal is located.

In one embodiment, the index of the reference signal resource is calculated by using the formula as follows:

I_{resource}=kₛ+Σᵢ₌₁^{s-1}Kᵢ;

where, kₛ denotes an index of a reference signal resource configured in a reference signal resource set s in the multiple reference signal resource sets, kₛ ∈ [1, Kₛ], and Kᵢ denotes the number of reference signal resources contained in a reference signal resource set i in the multiple reference signal resource sets.

Furthermore, as shown in FIG. 11, the network device 1100 may include a transceiver 1140, and an antenna 1150, etc. Functions of the above components are similar to those in the relevant art, and shall not be described herein any further. It should be noted that the network device 1100 does not necessarily include all the parts shown in FIG. 11, and furthermore, the network device 1100 may include parts not shown in FIG. 11, and the relevant art may be referred to.

The embodiment of this disclosure further provides a terminal equipment, however, this disclosure is not limited thereto, and it may also be another equipment.

FIG. 12 is a schematic diagram of the terminal equipment of the embodiment of this disclosure. As shown in FIG. 12, a terminal equipment 1200 may include a processor 1210 and a memory 1220, the memory 1220 storing data and a program and being coupled to the processor 1210. It should be noted that his figure is illustrative only, and other types of structures may also be used, so as to supplement or replace this structure and achieve a telecommunications function or other functions.

For example, the processor 1210 may be configured to execute a program to carry out the method for receiving signaling described in Embodiment 1. For example, the processor 1210 may be configured to execute the following control: receiving configuration information transmitted by a network device, the configuration information including time domain position information on transmitting a reference signal at multiple time intervals by using reference signal resources in a reference signal resource set; and receiving a triggering signaling transmitted by the network device, the triggering signaling being used to indicate transmitting the reference signal at the multiple time intervals by using the reference signal resources and indicate the terminal equipment to report channel state information.

For another example, the processor 1210 may be configured to execute a program to carry out the method for receiving signaling described in Embodiment 2. For example, the processor 1210 may be configured to execute the following control: receiving configuration information on multiple reference signal resource sets transmitted by a network device, the configuration information including time domain position information on transmitting a reference signal at multiple time intervals by using reference signal resources in the multiple reference signal resource sets; and receiving a triggering signaling transmitted by the network device, the triggering signaling being used to indicate transmitting the reference signal at the multiple time intervals by using the reference signal resources in the multiple reference signal resource sets, and indicate the terminal equipment to report channel state information.

As shown in FIG. 12, the terminal equipment 1200 may further include a communication module 1230, an input unit 1240, a display 1250, and a power supply 1260; wherein functions of the above components are similar to those in the relevant art, which shall not be described herein any further. It should be noted that the terminal equipment 1200 does not necessarily include all the parts shown in FIG. 12, and the above components are not necessary. Furthermore, the terminal equipment 1200 may include parts not shown in FIG. 12, and the relevant art may be referred to.

An embodiment of this disclosure provides a computer readable program, which, when executed in a network device, will cause the network device to carry out the method for indicating signaling described in Embodiment 1 or 2.

An embodiment of this disclosure provides a computer storage medium, including a computer readable program, which will cause a network device to carry out the method for indicating signaling described in Embodiment 1 or 2.

An embodiment of this disclosure provides a computer readable program, which, when executed in a terminal equipment, will cause the terminal equipment to carry out the method for receiving signaling described in Embodiment 1 or 2.

An embodiment of this disclosure provides a computer storage medium, including a computer readable program, which will cause a terminal equipment to carry out the method for receiving signaling described in Embodiment 1 or 2.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIGS. 8-10 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

For implementations of this disclosure containing the above embodiments, following supplements are further disclosed.

Supplement 1. An apparatus for receiving signaling, including:

a configuration receiving unit configured to receive configuration information transmitted by a network device, the configuration information including time domain position information on transmitting a reference signal at multiple time intervals by using reference signal resources in a reference signal resource set; and

a signaling receiving unit configured to receive a triggering signaling transmitted by the network device, the triggering signaling being used to indicate transmitting the reference signal at the multiple time intervals by using the reference signal resources and indicate the terminal equipment to report channel state information.

Supplement 2. The apparatus according to supplement 1, wherein the time domain position information at least includes: an offset on a timeline of a time interval at which the reference signal is transmitted by using the reference signal resources in the reference signal resource set relative to a time interval of the triggering signaling;

the offset being used to indicate a time domain position of a first time interval in the multiple time intervals.

Supplement 3. The apparatus according to supplement 1, wherein the reference signal resources are aperiodic channel state information reference signal resources, the reference signal is aperiodic channel state information reference signal, and the time interval includes at least one of the following: a slot, a frame, and a subframe;

and the configuration information is carried by one or more radio resource control messages.

Supplement 4. The apparatus according to supplement 2, wherein the configuration information further contains a first field, the first field indicating time domain positions of the reference signal resources in the reference signal resource set used for transmitting the reference signal at the multiple time intervals.

Supplement 5. The apparatus according to supplement 4, wherein the first field includes N parameters, one parameter in the N parameters corresponding to one time interval in the multiple time intervals; where, N is the number of the multiple time intervals.

Supplement 6. The apparatus according to supplement 5, wherein one parameter in the N parameters is used to indicate the number of the reference signal resources used at the time interval.

Supplement 7. The apparatus according to supplement 5, wherein one parameter in the N parameters is used to indicate an index of a first reference signal resource used at the time interval in the reference signal resource set.

Supplement 8. The apparatus according to supplement 7, wherein the configuration information further contains a second field, the second field being used to configure the reference signal resource set, and the index being determined by a configuration order of the first reference signal resource in the second field.

Supplement 9. The apparatus according to supplement 4, wherein the first field contains a parameter M, the parameter M denoting that one or more reference signal resources in the reference signal resource set are used for transmitting the reference signal at M consecutive time intervals starting from the time interval indicated by the offset.

Supplement 10. The apparatus according to supplement 1, wherein the configuration information contains a bitmap used for indicating the time intervals at which the reference signal is transmitted;

and wherein, the bitmap contains S bits, the S bits corresponding to S consecutive time intervals starting from the time interval of the triggering signaling, and a bit in the S bits being used to indicate transmitting or not transmitting the reference signal within a corresponding time interval by using one or more of the reference signal resources in the reference signal resource set.

Supplement 11. The apparatus according to supplement 1, wherein the apparatus further includes:

an information transmitting unit configured to transmit channel state information to the network device, the channel state information being used by the network device to determine a reference signal resource indicator or a beam indicator reported by the terminal equipment.

Supplement 12. The apparatus according to supplement 11, wherein the reference signal resource indicator is used to indicate a reference signal resource, and is an index of the reference signal resource;

and the index of the reference signal resource is an index in the reference signal resource set where the reference signal resource is located, or is an index of the reference signal resource in a resource where the reference signal is located.

Supplement 13. The apparatus according to supplement 12, wherein the index of the reference signal resource is calculated by using the formula as follows:

I_{resource}=k+K·p;

where, k denotes the index of the reference signal resource in the reference signal resource set, K denotes the number of reference signal resources contained in the reference signal resource set, p=[Iₛₗₒₜ−(l+X)], Iₛₗₒₜ denoting an index of the time interval of the reference signal resource, X denoting the offset, and l denoting an index of the time interval of the triggering signaling.

Supplement 14. The apparatus according to supplement 12, wherein the index of the reference signal resource is calculated by using the formula as follows:

I_{resource}=k+K·p;

where, k denotes the index of the reference signal resource in the reference signal resource set, K denotes the number of reference signal resources contained in the reference signal resource set,

p denotes that the reference signal resource needing to be reported by the terminal equipment is used at a time interval to which a (p+1)-th bit set to be 1 in the bitmap corresponds, or, p denotes that the reference signal resource needing to be reported by the terminal equipment is used at a time interval to which a (p+1)-th bit set to be 0 in the bitmap corresponds.

Supplement 15. An apparatus for receiving signaling, including:

a configuration receiving unit configured to receive configuration information on multiple reference signal resource sets transmitted by a network device, the configuration information including time domain position information on transmitting a reference signal at multiple time intervals by using reference signal resources in the multiple reference signal resource sets; and

a signaling receiving configured to receive a triggering signaling transmitted by the network device, the triggering signaling being used to indicate transmitting the reference signal at the multiple time intervals by using the reference signal resources in the multiple reference signal resource sets, and indicate the terminal equipment to report channel state information.

Supplement 16. The apparatus according to supplement 15, wherein the time domain position information at least includes: an offset on a timeline of a time interval at which the reference signal is transmitted by using the reference signal resources in the multiple reference signal resource sets relative to a time interval of the triggering signaling,

offsets of the multiple reference signal resource sets being different.

Supplement 17. The apparatus according to supplement 15, wherein the reference signal resources are aperiodic channel state information reference signal resources, the reference signal is an aperiodic channel state information reference signal, and the time interval includes at least one of the following: a slot, a frame, and a subframe.

Supplement 18. The apparatus according to supplement 15, wherein the apparatus further includes:

an information transmitting unit configured to transmit channel state information to the network device, the channel state information being used by the network device to determine a reference signal resource indicator or a beam indicator reported by the terminal equipment, according to the channel state information.

Supplement 19. The apparatus according to supplement 18, wherein the reference signal resource indicator is used to indicate a reference signal resource, and is an index of the reference signal resource;

and the index of the reference signal resource is an index in a reference signal resource set where the reference signal resource is located, or is an index of the reference signal resource in a resource where the reference signal is located.

Supplement 20. The apparatus according to supplement 19, wherein the index of the reference signal resource is calculated by using the formula as follows:

I_{resource}=kₛΣᵢ₌₁^{s-1}Kᵢ;

where, kₛ denotes an index of a reference signal resource configured in a reference signal resource set s in the multiple reference signal resource sets, kₛ ∈ [1, Kₛ], and Kᵢ denotes the number of reference signal resources contained in a reference signal resource set i in the multiple reference signal resource sets.

What is claimed is:

1. An apparatus for indicating signaling, comprising:
a memory that stores a plurality of instructions; and
a processor coupled to the memory and configured to execute the instructions to:
transmit configuration information to a terminal equipment, the configuration information comprising time domain position information on transmitting a reference signal at multiple time intervals by using reference signal resources in a reference signal resource set; and
transmit a triggering signaling to the terminal equipment, the triggering signaling being used to indicate transmitting the reference signal at the multiple time intervals by using the reference signal resources and indicate the terminal equipment to report channel state information.

2. The apparatus according to claim 1, wherein the time domain position information at least comprises: an offset on a timeline of a time interval at which the reference signal is transmitted by using the reference signal resources in the reference signal resource set relative to a time interval of the triggering signaling;
the offset being used to indicate a time domain position of a first time interval in the multiple time intervals.

3. The apparatus according to claim 1, wherein the reference signal resources are aperiodic channel state information reference signal resources, the reference signal is aperiodic channel state information reference signal, and the time interval comprises at least one of the following: a slot, a frame, and a subframe;
and the configuration information is carried by one or more radio resource control messages.

4. The apparatus according to claim 2, wherein the configuration information further contains a first field, the first field indicating time domain positions of the reference signal resources in the reference signal resource set used for transmitting the reference signal at the multiple time intervals.

5. The apparatus according to claim 4, wherein the first field comprises N parameters, one parameter in the N parameters corresponding to one time interval in the multiple time intervals; where, N is a number of the multiple time intervals.

6. The apparatus according to claim 5, wherein one parameter in the N parameters is used to indicate the number of the reference signal resources used at the time interval.

7. The apparatus according to claim 5, wherein one parameter in the N parameters is used to indicate an index of a first reference signal resource used at the time interval in the reference signal resource set.

8. The apparatus according to claim 7, wherein the configuration information further contains a second field, the second field being used to configure the reference signal resource set, and the index being determined by a configuration order of the first reference signal resource in the second field.

9. The apparatus according to claim 4, wherein the first field contains a parameter M, the parameter M denoting that one or more reference signal resources in the reference signal resource set are used for transmitting the reference signal at M consecutive time intervals starting from the time interval indicated by the offset.

10. The apparatus according to claim 1, wherein the configuration information contains a bitmap used for indicating the time intervals at which the reference signal is transmitted;
and wherein, the bitmap contains S bits, the S bits corresponding to S consecutive time intervals starting from the time interval of the triggering signaling, and a bit in the S bits being used to indicate transmitting or not transmitting the reference signal within a corresponding time interval by using one or more of the reference signal resources in the reference signal resource set.

11. The apparatus according to claim 1, wherein the processor is further configured to:
receive channel state information from the terminal equipment; and
determine a reference signal resource indicator or a beam indicator reported by the terminal equipment, according to the channel state information.

12. The apparatus according to claim 11, wherein the reference signal resource indicator is used to indicate a reference signal resource, and is an index of the reference signal resource;
and wherein, the index of the reference signal resource is an index of the reference signal resource within the reference signal resource set, or is an index of the reference signal within the reference signal resource.

13. The apparatus according to claim 12, wherein the index of the reference signal resource is calculated by using a formula as follows:
I_{resource}=k+K·p;
where, k denotes the index of the reference signal resource in the reference signal resource set, K denotes the number of reference signal resources contained in the reference signal resource set, p=[(Iₛₗₒₜ−(l+X)], Iₛₗₒₜ denoting an index of the time interval of the reference signal resource, X denoting the offset, and l denoting an index of the time interval of the triggering signaling;
or, p denotes that the reference signal resource needing to be reported by the terminal equipment is used at a time interval to which a (p+1)-th bit set to be 1 in the bitmap corresponds, or, p denotes that the reference signal resource needing to be reported by the terminal equipment is used at a time interval to which a (p+1)-th bit set to be 0 in the bitmap corresponds.

14. An apparatus for indicating signaling, comprising:
a memory that stores a plurality of instructions; and
a processor coupled to the memory and configured to execute the instructions to:
transmit configuration information on multiple reference signal resource sets to a terminal equipment, the configuration information comprising time domain position information on transmitting a reference signal at multiple time intervals by using reference signal resources in the multiple reference signal resource sets; and
transmit a triggering signaling to the terminal equipment, the triggering signaling being used to indicate transmitting the reference signal at the multiple time intervals by using the reference signal resources in the multiple reference signal resource sets, and indicate the terminal equipment to report channel state information.

15. The apparatus according to claim 14, wherein the time domain position information at least comprises: an offset on a timeline of a time interval at which the reference signal is transmitted by using the reference signal resources in the multiple reference signal resource sets relative to a time interval of the triggering signaling,
offsets of the multiple reference signal resource sets being different.

16. The apparatus according to claim 14, wherein the reference signal resources are aperiodic channel state information reference signal resources, the reference signal is an aperiodic channel state information reference signal, and the time interval comprises at least one of the following: a slot, a frame, and a subframe.

17. The apparatus according to claim 14, wherein the processor is further configured to:
receive channel state information from the terminal equipment; and
determine a reference signal resource indicator or a beam indicator reported by the terminal equipment, according to the channel state information.

18. The apparatus according to claim 17, wherein the reference signal resource indicator is used to indicate a reference signal resource, and is an index of the reference signal resource;
and wherein, the index of the reference signal resource is an index of the reference signal resource within a reference signal resource set , or is an index of the reference signal within the reference signal resource.

19. The apparatus according to claim 18, wherein the index of the reference signal resource is calculated by using the formula as follows:
I_{resource}=kₛ+Σᵢ₌₁^{s-1}Kᵢ;
where, kₛ denotes an index of a reference signal resource configured in a reference signal resource set s in the multiple reference signal resource sets, kₛ ∈ [1, Kₛ], and Kᵢ denotes the number of reference signal resources contained in a reference signal resource set i in the multiple reference signal resource sets.

20. A communication system, comprising:
a network device, comprising:
a memory that stores a plurality of instructions; and
a processor coupled to the memory and configured to execute the instructions to:
transmit configuration information on multiple reference signal resource sets to a terminal equipment, the configuration information comprising time domain position information on transmitting a reference signal at multiple time intervals by using reference signal resources in the multiple reference signal resource sets; and
transmit a triggering signaling to the terminal equipment, the triggering signaling being used to indicate transmitting the reference signal at the multiple time intervals by using the reference signal resources in the multiple reference signal resource sets, and indicate the terminal equipment to report channel state information.
